(19) United States
(12) Patent Application Publication
(10) Pub. No.: US 2016/0326881 A1
(43) Pub. Date: Nov. 10, 2016

(54) TURBOMACHINE BLADE

(71) Applicant: MTU Aero Engines AG, Muenchen (DE)

(72) Inventor: Andreas Hartung, Muenchen (DE)

(21) Appl. No.: 15/145,335

(22) Filed: May 3, 2016

(30) Foreign Application Priority Data
May 5, 2015 (EP) 15166391.1

(51) Int. Cl. F01D 5/16; F01D 25/06

(52) U.S. Cl. CPC F01D 5/16; F01D 25/06; F05D 2220/32; F05D 2230/21; F05D 2230/10; F05D 2260/96

(57) ABSTRACT

A blade, in particular a rotor blade, for a turbomachine, in particular a gas turbine, having an airfoil (10) for deflecting a working fluid that has a pressure side (11) and a suction side that are joined at a leading and a trailing edge (12, 13), and having a blade root (20); in the blade, a radial channel (6) being formed into which an impulse element (3) and a contact means (40.1-40.N; 41, 42) are introduced through a blade root-side insertion opening (23) that supports the impulse element with clearance of motion(s) in the axial and/or circumferential direction on the blade root side.

The work leading to this invention was funded in accordance with Grant Agreement no. CSJU-GAM-SAGE-2008-001 in the course of The European Union's Seventh Framework Program (FP7/2007-2013) for The Clean Sky Joint Technology Initiative.

This claims the benefit of European Patent Application EP 15166391.1 filed May 5, 2015 and hereby incorporated by reference herein.

The present invention relates to a blade, in particular a rotor blade for a turbomachine, in particular a gas turbine, having at least one such blade, as well as to a method for manufacturing such a blade.

### BACKGROUND

The British Patent Application GB 2 322 426 A1 describes a propeller blade having a radial conduit into which a damping element is inserted through a blade tip-side insertion opening for the dissipative damping of torsional modes. It is elastically secured without play by O-rings within the conduit.

### SUMMARY OF THE INVENTION

It is an object of an embodiment of the present invention to improve the performance characteristics of turbomachines, in particular of gas turbines.

The present invention provides that a blade for a turbomachine, in particular at least one blade of a turbomachine, have an airfoil for deflecting a working fluid that has a pressure and a suction side that are joined at a leading and a trailing edge, and have a blade root.

An embodiment provides that the blade be a rotor blade, which may, in particular, be detachably joined to a rotatably mounted rotor of the turbomachine, in particular by form- and/or friction-locking engagement, or permanently, in particular in a material-to-material bond, or integrally formed therewith. Another embodiment provides that the blade be a guide vane, which, in particular, may be detachably joined to a housing of the turbomachine, in particular by form- and/or friction-locking engagement, or permanently, in particular in a material-to-material bond, or integrally formed therewith.

An embodiment provides that the turbomachine be a gas turbine, in particular an aircraft engine gas turbine.

In an embodiment, the blade root has a shroud, respectively a platform and/or a fastening portion, in particular for the detachable joining, in particular by form- and/or friction-locking engagement, or permanently, in particular in a material-to-material bond, to the rotor or housing. Particularly in the case of a rotor blade, the shroud may be a radially inner, respectively inner shroud or, in particular in the case of a guide vane, a radially outer, respectively an outer shroud. In an embodiment, the fastening portion may feature one or a plurality of shoulders, and/or be configured on the side of the shroud opposite the airfoil. In particular, it may feature a fir tree-like profile.

The airfoil may likewise have a shroud, in particular in the case of a rotor blade, a radially outer shroud, respectively in the case of a guide vane, a radially inner shroud. The blade may likewise feature a shroudless airfoil. An airfoil height may, in particular, be measured, respectively defined from the blade root, in particular the shroud, respectively the platform thereof, to the airfoil tip, respectively the side of a shroud of the airfoil opposite the blade root.

In an embodiment, a, in particular straight, respectively linear radial channel is formed in the blade, in particular in the airfoil and/or root thereof. In the context of the present invention, a radial channel (also) extends in particular in the radial direction of the turbomachine; in particular, a longitudinal direction, respectively a direction of extent of the radial channel may form an angle of at least 70°, in particular of at least 80°, and/or at most of 110°, in particular at most of 100° with an axis of rotation of the turbomachine.

It should generally be noted that, unless stated otherwise in the specific context, the terms “radial,” respectively “radial direction,” “axial,” respectively “axial direction” and “circumferential direction” always refer to the axis of rotation of the turbomachine when the blade is mounted therein in the intended manner.

In an embodiment, the blade, in particular the airfoil and/or root thereof, are manufactured as a solid material body, respectively of a solid piece, in particular by primary shaping, in particular by casting. In another embodiment, the channel is produced by removal of material, in particular by machining, in particular is bored.

In another embodiment, the blade, in particular the airfoil and/or root thereof, are manufactured as a hollow body, in particular by joining or primary shaping, in particular by welding or casting, respectively features (at least) one hollow space, respectively cavity. In a further refinement, the channel may be at least partially formed by this hollow space. In particular, the channel may be produced upon primary shaping of the blade.

An embodiment provides that an impulse element and a contact means be introduced into the channel, in particular in succession, through a blade root-side insertion opening.

In an embodiment, the entry opening is configured in the shroud of the blade root. This makes it advantageously possible in one embodiment to reduce a radial channel length, respectively height. In another embodiment, the entry opening is configured in the fastening portion of the blade root, in particular in a (radial) end face of the blade root opposite the airfoil. In an embodiment, the access to the channel may hereby be advantageously facilitated, and/or the channel may be sealed by securing the fastening portion, optionally additionally.

In an embodiment, the impulse element is accommodated in the channel with clearance of motion in the axial and/or circumferential direction of the turbomachine and is supported by the contact means on the blade root side, respectively toward the blade root, in particular in the case of a rotor blade, radially inwardly; in the case of a guide vane, radially outwardly.

In an embodiment, one or a plurality of torsional modes of the blade may be detuned by an impulse element that is accommodated in the channel without being attached or restrained, with clearance of motion in the axial and/or circumferential direction of the turbomachine: in contrast to a dissipative damping, in operation, the impulse element imparts, in particular elastic impacts to the blade, respectively is adapted for this purpose. It has been found that such impact contacts may be used to advantageously detune the (torsional) modes of the blade.

In an embodiment, the impulse element is spherical or cylindrical and/or has a mass of at least 0.01 g and/or at most of 0.075 g. An embodiment additionally or alternatively provides that a density of the impulse element be at most 80%, in particular at most 70% of a density of the airfoil. This makes it possible to achieve an especially advantageous detuning.

In an embodiment, the impulse element, which is introduced through the insertion opening, is advantageously radially spaced apart from the insertion opening by the contact means; thus, it may, in particular, be advantageously configured in a radial position, respectively at a height of the blade that is favorable for detuning a specific torsional mode. Accordingly, in an embodiment, an end face of the contact means facing the impulse element is configured at a radial height of the blade where an amplitude, in particular of a first, second or third torsional mode, respectively eigenmode of the blade, in particular of the airfoil, has at least 50%, in particular at least 75%, preferably at least 90% of a maximum amplitude of the torsional eigenmode of the blade, in particular of the airfoil.

In an embodiment, the contact means, which, accordingly, is then multipart, has a plurality of, in particular at least two, at least three or more elements that are radially movable relative to each other. In an embodiment, one or more elements of the contact means are essentially spherical or cylindrical and/or identical in design to the impulse element. In an embodiment, this makes it possible to simplify the manufacturing, respectively filling of the blade, in particular to avoid mixing up structurally different impulse elements and elements of the contact means. Additionally or alternatively, elements of the contact means may advantageously function, respectively be designed as (further) impulse elements, in particular for detuning bending and/or (other) torsional modes. In an embodiment, only (maximally) one impulse element is configured (in each case) at a radial height of the blade. In an embodiment, this makes it possible to improve detuning.

Additionally or alternatively, in an embodiment, the, in particular one-part contact means may have one or a plurality of, in particular cylindrical pins, in particular be made of the same, whose dimension in the longitudinal direction of the channel in an embodiment is at least twice, in particular five times the dimension thereof orthogonally thereto. In an embodiment, one or more such, in particular slender pins make(s) it possible for the impulse element to be very advantageously spaced apart from the insertion opening. In an embodiment, the, respectively at least one of the pins features an annular or full-circle disk-shaped cross section. The, respectively at least one of the pins may be hollow or solidly formed over the entire length thereof or partial sections thereof. Similarly, the, respectively at least one of the pins also has other, in particular cross-shaped cross sections, at least in portions thereof.

In an embodiment, the, in particular one-part contact means may additionally or alternatively have a sleeve within which the impulse element is accommodated with clearance of motion in the axial and/or circumferential direction of the turbomachine.

Thus, in an embodiment, the impulse element may impart impacts in the axial and/or circumferential direction of the turbomachine to the channel formed in the, respectively by the blade, itself, respectively directly, or to the sleeve, respectively (indirectly) via the same to the channel, respectively the blade, respectively be provided, respectively adapted for this purpose.

In an embodiment, the sleeve may be joined to the, respectively a pin of the contact means or be integrally formed therewith. In an embodiment, the sleeve is open away from the blade root, respectively toward an end face of the channel opposite the insertion opening, which may make it easier to accommodate the impulse element in the sleeve. In an embodiment, the sleeve is closed away from the blade root, respectively toward an end face of the channel opposite the insertion opening, particularly once the impulse element has been accommodated, thereby making it possible to define an impact chamber that is also advantageously closed in the longitudinal direction of the channel.

Thus, in an embodiment, the impulse element may impart impacts in the longitudinal direction of the channel away from the insertion opening, itself, respectively directly, or to the sleeve, respectively (indirectly) via the same to the channel, respectively the blade, or also be guided, respectively, be abutting, in particular as a function of centrifugal force, respectively be provided, respectively adapted for this purpose.

In an embodiment, the contact means, in particular one or a plurality of the elements that are movable relative to each other in the longitudinal direction of the channel and/or the pin, respectively one of the pins in the channel is/are configured in the axial and/or circumferential direction of the turbomachine by form-, friction-locking engagement, and/or in a material-to-material bond or with clearance of motion. The contact means may be advantageously fixed in position by a form-, friction-locking engagement, and/or in a material-to-material configuration, in particular additionally or alternatively, to form a sealing closure that is explained more closely in the following. A contact means, which is configured with clearance of motion, may simplify the manufacturing of the blade, in particular the filling of the channel, and/or the contact means, in particular the movable elements may additionally function as (further) impulse elements.

In an embodiment, a, in particular minimum and/or maximum extent of the contact means in the longitudinal direction of the channel, in particular between an end face on the side of, respectively proximate to the impulse element and an end face of the contact means most distant from the impulse element, is at least twice, in particular at least five times an, in particular minimum and/or maximum extent of the impulse element in the longitudinal direction of the channel.

Additionally or alternatively, in an embodiment, a, in particular minimum and/or maximum extent of the contact means in the longitudinal direction of the channel, in particular between an end face on the side of, respectively proximate to the impulse element and an end face of the contact means most distant from the impulse element is at least 25%, in particular at least 50%, in particular at least 75%, of a, in particular minimum and/or maximum extent in the longitudinal direction of the channel and/or of the radial height of the blade root and/or of the airfoil, in particular of a (common, respectively total) extent, respectively radial height of the blade root and of the airfoil, together.

In an embodiment, this makes it possible for the impulse element to be advantageously positioned in advance.

In an embodiment, the channel is partially or completely closed, respectively sealed by a sealing closure, in particular a plug, respectively cover. In another embodiment, the sealing closure is configured at, in particular in the insertion opening and fastened, in particular in a material-to-material bond, by form- and/or friction-locking engagement, in particular by welding, soldering or adhesive bonding. This advantageously, at least essentially, makes possible an uninterrupted outer contour of the blade in the region of the insertion opening. In another embodiment, the sealing closure is configured in the channel to be radially spaced apart from the insertion opening, and is fastened in the channel, in particular in a material-to-material bond, by form- and/or friction-locking engagement, in particular by welding, soldering or adhesive bonding.

In an embodiment, the sealing closure is joined to the contact means, in particular in a material-to-material bond, by form- and/or friction-locking engagement, or integrally formed therewith. This makes it possible for the contact means to be advantageously manipulated and/or, in particular additionally secured in position.

In an embodiment, the impulse element is configured in a half that faces away from the blade root, in particular in a third that faces away from the blade root, in particular in a fourth that faces away from the blade root of the airfoil, respectively of the radial height thereof. In other words, in an embodiment, the impulse element is configured in a radially outer half, in particular a radially outermost third, in particular a radially outermost fourth of the airfoil of the rotor blade, respectively in a radially inner half, in particular a radially innermost third, in particular a radially innermost fourth of the airfoil of the guide vane. Conversely, in another embodiment, the impulse element is configured in a half that faces the blade root, in particular in a third that faces the blade root, in particular in a fourth that faces the blade root of the airfoil, respectively of the radial height thereof.

Additionally or alternatively, in an embodiment, the impulse element is configured in a half that faces the leading edge, in particular in a third that faces the leading edge, in particular in a fourth that faces the leading edge of the airfoil, respectively of the extent thereof in the axial direction of the turbomachine and or along the chord length. In other words, in an embodiment, the impulse element is configured in an axially leading half, in particular an axially most leading third, in particular an axially most leading fourth of the airfoil, respectively in the vicinity of the leading edge thereof. Conversely, in another embodiment, the impulse element is configured in a half that faces away from the leading edge, respectively that faces the trailing edge, in particular in a third that faces away from the leading edge, respectively that faces the trailing edge, in particular in a fourth of the airfoil that faces away from the leading edge, respectively that faces the trailing edge.

In an embodiment, torsional modes may hereby be very advantageously detuned.

In an embodiment, between the contact means and an, in particular blade-fixed further radial contact that is opposite therefrom, the impulse element features a clearance of motion in the longitudinal direction of the channel. In an embodiment, the impulse element may engage on the further radial contact, in particular as a function of centrifugal force, or impart impulses thereto, respectively be provided, respectively adapted for this purpose.

In an embodiment, the clearance of motion of the impulse element in the axial, circumferential and/or longitudinal direction of the channel is at least 0.01 mm, in particular at least 0.1 mm, and/or at most 2 mm, in particular at most 1.5 mm. In an embodiment, an especially advantageous detuning of torsional modes is hereby possible.

### BRIEF DESCRIPTION OF THE DRAWINGS

Further advantageous embodiments of the present invention will become apparent from the dependent claims and the following description of preferred embodiments. To this end, the drawings show, partly in schematic form, in:

FIG. 1: a rotor blade of a gas turbine in accordance with an embodiment of the present invention in a plan view in the circumferential direction;

FIG. 2: a rotor blade of a gas turbine in accordance with another embodiment of the present invention in a view that corresponds to FIG. 1; and

FIG. 3: a rotor blade of a gas turbine in accordance with another embodiment of the present invention in a view that corresponds to FIG. 1.

### DETAILED DESCRIPTION

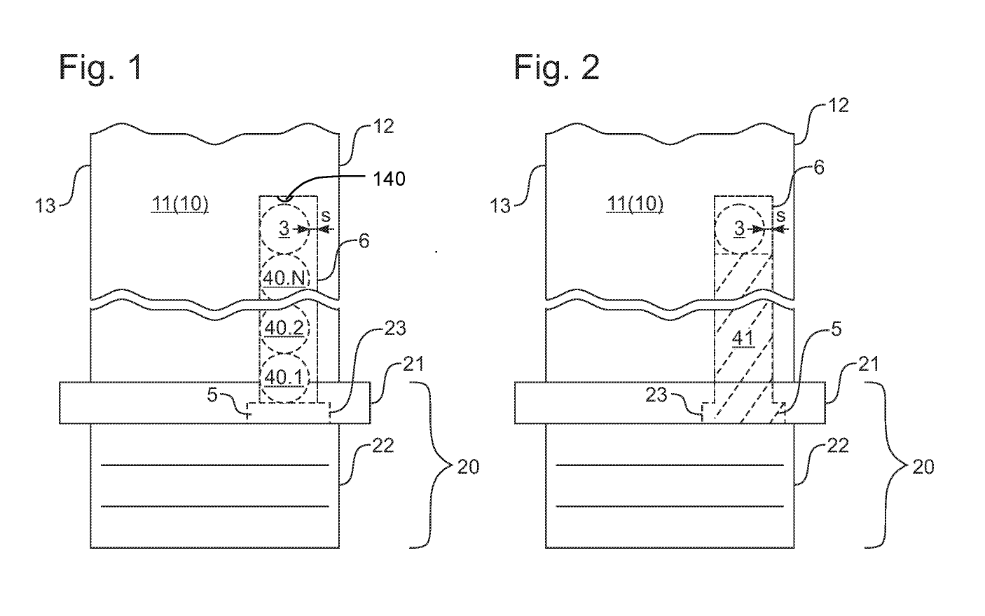

FIG. 1 shows a rotor blade of a turbomachine, in particular of an aircraft engine gas turbine in accordance with an embodiment of the present invention, in a plan view in the circumferential direction.

The blade features an airfoil 10 for deflecting a working fluid that has a pressure side 11 and a suction side, which is circumferentially opposite and is, therefore, not visible in FIG. 1, that are joined at a leading edge 12 and a trailing edge 13, and has a blade root 20.

Blade root 20 has a radially inner, respectively an inner shroud 21 and a fastening portion 22 having a fir tree-like profile. However, the profile could also have a different, for example, dovetailed design, as long as it is suited for entering into an interlocking connection with a groove of a rotor disk (not shown) having a complementary form.

Airfoil 10, which is only partially shown in FIG. 1, may likewise have a (radially outer) shroud or similarly be shroudless.

A straight, radial channel 6 is formed in the blade, in particular in airfoil 10 thereof and in inner shroud 21 of blade root 20 thereof. It is indicated by dashed lines in the plan view of FIG. 1.

In an embodiment, airfoil 10 is manufactured as a solid material body, respectively as a solid piece, in particular by primary shaping, in particular by casting, and channel 6 is produced by removal of material, in particular by machining, in particular is bored. In another embodiment, airfoil 10 is manufactured as a hollow body. Channel 6 may then at least be partially formed by this hollow space.

A spherical impulse element 3 and a contact means 40.1-40.N are successively introduced into channel 6 through a blade root-side insertion opening 23 that is configured in shroud 21 of blade root 20.

Impulse element 3 is accommodated in channel 6 without being attached or restrained and with clearance of motion s axially (horizontally in FIG. 1) and circumferentially (perpendicularly to the plane of the drawing of FIG. 1) of the aircraft engine gas turbine in channel 6 and supported by contact means 40.1-40.N on the blade-root side, respectively toward blade root 20, thus in the case of the rotor blade, radially inwardly (downwardly in FIG. 1).

The end face (at the top in FIG. 1) of contact means 40.1-40.N facing impulse element 3 is configured at a radial height of the blade where an amplitude of a first, second or third torsional mode of the blade features at least 75% of a maximum amplitude of the torsional eigenmode of the blade. Not included in the specific embodiment shown in FIG. 1 is the position of the end face of contact means 40.1-40.N facing impulse element 3 that results when the blade is not moving, and blade root 20 is vertically oriented underneath airfoil 10.

In the embodiment of FIG. 1, the multipart contact means has a plurality of spherical elements 40.1-40.N that are radially movable relative to each other and are identical in design to impulse element 3. Thus, in each case, only maximally one impulse element is configured at a radial height of the blade.

Elements 40.1-40.N that are movable relative to each other in the longitudinal direction of the channel are configured axially and circumferentially in the channel and may thus advantageously function as further impulse elements.

A maximum extent of contact means 40.1-40.N in the longitudinal direction of the channel between an impulse element-side, respectively-proximate end face (at the top in FIG. 1) and an impulse-element most distant end face of the contact means (at the bottom in FIG. 1) is at least five times a maximum extent of impulse element 3 in the longitudinal direction of the channel and at least 50% of a maximum extent in the longitudinal direction of the channel and of the radial height of airfoil 10.

Channel 6 is sealed by a sealing closure in the form of a cover 5 that is configured at insertion opening 23 and, in particular is fastened in a material-to-material bond, by form- and/or friction-locking engagement, in particular by welding, soldering or adhesive bonding.

Impulse element 3 is configured in a half of airfoil 10 facing away from the blade root, respectively in the radially outer half thereof, respectively of the radial height thereof, and in a leading edge-facing, respectively axially most leading fourth (to the right in FIG. 1) of airfoil 10.

Between contact means 40.1-40.N and a blade-fixed further radial contact 140 that is opposite therefrom, impulse element 3 likewise features a clearance of motion in the longitudinal direction of the channel.

Clearance of motion s of impulse element 3 in the axial and circumferential direction is between 0.1 mm and 1.5 mm.

FIG. 2 shows a rotor blade of a turbomachine, in particular of an aircraft engine gas turbine, in accordance with another embodiment of the present invention in a view that corresponds to FIG. 1. Corresponding features are identified by identical reference numerals, so that reference is made to the above description, and the differences will be discussed below.

In the embodiment of FIG. 2, the contact means is composed of a slender pin 41, whose dimension in the longitudinal direction of the channel (vertical in FIG. 2) is at least five times the dimension thereof orthogonally thereto. Pin 41 is positioned in channel 6 in the axial and/or circumferential direction by form- or friction-locking engagement and thereby secured.

Sealing closure 5 is integrally formed with pin 41.

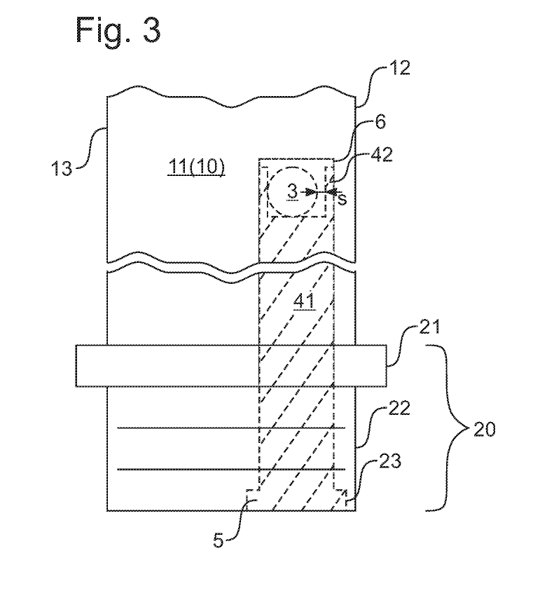

FIG. 3 shows a rotor blade of a turbomachine, in particular of an aircraft engine gas turbine, in accordance with another embodiment of the present invention in a view that corresponds to FIG. 1, 2. Corresponding features are identified by identical reference numerals, so that reference is made to the above description, and the differences will be discussed below.

In the embodiment of FIG. 3, impulse element 3 is accommodated with clearance of motion s in the axial and circumferential direction of the aircraft engine gas turbine in a sleeve 42 of the contact means that is joined in a material-to-material bond or integrally with pin 41, and is open away from the blade root, respectively toward an end face of channel 6 opposite insertion opening 23 (upwardly in FIG. 3).

Moreover, in the embodiment of FIG. 3, insertion opening 23 is located in a radial end face (at the bottom of FIG. 3) of fastening portion 22 of blade root 20 opposite airfoil 10. This specific embodiment is particularly advantageous when the blade is a hollow blade where channel 6 is formed at least in some sections by the existing cavity of the blade and thus not subsequently, for example by a bore. In this case, to prevent impulse element 3 from becoming uncontrollably dislocated within the cavity of the hollow blade, the range of motion in this specific embodiment is essentially defined by the embodiment of sleeve 42. It may also be envisaged to seal the radially outer end (at the top of FIG. 3) of the sleeve, for example, in a material-to-material bond, by form- or friction-locking engagement, in order for the desired range of motion of impulse element 3 to be fully defined by sleeve 42. In such a case, it is not yet even necessary for the cavity of the hollow blade to provide a contact for the impulse element radially outwardly at the appropriate location.

Although exemplary embodiments are explained in the preceding description, many modifications are possible. It should also be appreciated that the exemplary embodiments are merely examples and in no way are intended to restrict the scope of protection, the uses, or the design. Rather, the preceding description provides one skilled in the art with a guideline for realizing at least one exemplary design, it being possible for various modifications to be made, particularly with regard to the function and configuration of the described components, without departing from the scope of protection as is derived from the claims and the combinations of features equivalent thereto.

### LIST OF REFERENCE NUMERALS

10 airfoil

11 pressure side

12 leading edge

13 trailing edge

20 blade root

21 inner shroud

22 fastening portion

23 insertion opening

3 impulse element

40.1 . . . 40.N elements (contact means) that are movable in the longitudinal direction of the channel

41 pin (contact means)

42 sleeve (contact means)

5 sealing closure

6 channel

s clearance of motion

What is claimed is:

1. A blade comprising:
an airfoil for deflecting a working fluid, the airfoil having a pressure side and a suction side joined at a leading and a trailing edge; and
a blade root;
a radial channel being formed in the blade, an impulse element and a contact being introduced through an insertion opening in a blade root-side, the contact supporting the impulse element on the blade root side with clearance of motion in an axial or circumferential direction.

2. The blade as recited in claim 1 wherein the contact has a plurality of elements radially movable relative to each other, or a pin, or a sleeve open away from the blade root, the impulse element being accommodated in the sleeve with clearance of motion in the axial or circumferential direction.

3. The blade as recited in claim 1 wherein the contact is configured in the channel in the axial or circumferential direction by form-, friction-locking engagement, or in a material-to-material bond or with clearance of motion.

4. The blade as recited in claim 1 wherein an extent of the contact in a longitudinal direction of the channel is at least twice an extent of the impulse element in the longitudinal direction of the channel, or at least 25% of an extent of the blade root or of the airfoil in the longitudinal direction of the channel.

5. The blade as recited in claim 1 further comprising a sealing closure closing the channel.

6. The blade as recited in claim 5 wherein the sealing closure is configured at the insertion opening or radially spaced apart therefrom in the channel and is fastened thereto.

7. The blade as recited in claim 6 wherein the sealing closure is fastened to the channel with a material-to-material bond, or by form-or friction-locking engagement.

8. The blade as recited in claim 5 wherein the sealing closure is joined to the contact.

9. The blade as recited in claim 8 wherein the sealing closure is joined to the contact with a material-to-material bond, or by form-or friction-locking engagement or is integrally formed therewith.

10. The blade as recited in claim 1 wherein the impulse element is configured in a half of the airfoil facing or faces away from the blade root or the leading edge.

11. The blade as recited in claim 1 wherein, between the contact and a further radial contact opposite from the contact, the impulse element has a clearance of motion in the longitudinal direction of the channel.

12. The blade as recited in claim 11 wherein the further radial contact is fixed to the blade.

13. The blade as recited in claim 1 wherein the blade root has a shroud or a fastener

14. The blade as recited in claim 13 wherein the insertion opening is configured in the shroud or the fastening portion.

15. The blade as recited in claim 1 wherein the clearance of motion of the impulse element in the axial or circumferential direction or in a longitudinal direction of the channel is at least 0.01 mm or at most 2 mm.

16. The blade as recited in claim 1 wherein the blade is manufactured as a hollow body or as a solid material body.

17. The blade as recited in claim 1 wherein the airfoil is manufactured as a hollow body or as a solid material body.

18. A turbomachine comprising at least one blade as recited in claim 1.

19. A rotor blade for a turbomachine comprising the blade as recited in claim 1.

20. A gas turbine comprising the rotor blade as recited in claim 19.

21. A method for manufacturing a blade as recited in claim 1 comprising introducing the impulse element and the contact into the radial channel through the insertion opening.
